(19) United States
(12) Patent Application Publication
(10) Pub. No.: US 2025/0023372 A1
(43) Pub. Date: Jan. 16, 2025

(54) FOLDABLE WIRELESS CHARGER

(71) Applicant: Longconn Electronics (Shenzhen) Co., Ltd., Shenzhen (CN)

(72) Inventor: LIJUN WEI, Shenzhen (CN)

(21) Appl. No.: 18/235,875

(22) Filed: Aug. 20, 2023

(30) Foreign Application Priority Data
Jul. 14, 2023 (CN) 202321867281.1

(51) Int. Cl. H02J 7/00; H02J 50/10

(52) U.S. Cl. CPC H02J 7/0044; H02J 50/10

(57) ABSTRACT

Disclosed is a foldable wireless charger, including a cable, a base, a support rod and a charger body connected in sequence, the support rod is rotationally connected to the base and the charger body, respectively, a cable outlet is arranged on the base, a cable runway is arranged inside the support rod, a cable inlet is arranged on the charger body, one end of the cable is located in the base, and the other end of the cable is extended into the charger body through the cable outlet, the cable runway and the cable inlet in sequence. The foldable wireless charger can hide the cable configured to supply power to the wireless charging transmission module in the charger body, which effectively reduces the risk of damage to the cable, helps in prolonging the service life of the foldable wireless charger, and improves the user experience.

### CROSS-REFERENCE TO RELATED APPLICATIONS

This is a U.S. patent application which claims the priority and benefit of Chinese Patent Application Number 202321867281.1, filed on Jul. 14, 2023, the disclosure of which is incorporated herein by reference in its entirety.

### TECHNICAL FIELD

The present disclosure relates to the technical field of charging equipment, in particular to a foldable wireless charger.

### BACKGROUND

Upon debuting, wireless chargers have been widely acclaimed by consumers because they do not need to use cables to connect terminal devices when charging.

In order to allow users to charge the terminal devices in both flat and oblique positions, foldable wireless chargers came into being, so that the users can charge the terminal devices while using them. A foldable wireless charge includes a base, a support rod and a charger body connected in sequence, and the support rod is rotationally connected to the base and the charger body, respectively. However, in the prior art, when the foldable wireless charge is unfolded, a cable connecting a wireless charging transmission module in the charger body is exposed, which not only poses a greater risk of damage to the cable, but also affects the aesthetics of the foldable wireless charger and affects the user experience as well.

### SUMMARY

A technical problem solved by the present disclosure is a foldable wireless charger with a built-in cable.

In order to solve the above technical problem, the present disclosure provides a technical solution: a foldable wireless charger, including a cable, a base, a support rod and a charger body connected in sequence, where the support rod is rotationally connected to the base and the charger body, respectively, a cable outlet is arranged on the base, a cable runway is arranged inside the support rod, a cable inlet is arranged on the charger body, one end of the cable is located in the base, and the other end of the cable is extended into the charger body through the cable outlet, the cable runway and the cable inlet in sequence.

The present disclosure has the beneficial effects: the foldable wireless charger can charge terminal devices (including but not limited to cell phones) placed flatwise when it is in the folded state, and can also charge terminal devices placed obliquely when it is in the unfolded state, which is convenient for users to use. At the same time, the foldable wireless charger can hide the cable configured to supply power to the wireless charging transmission module in the charger body, which effectively reduces the risk of damage to the cable, helps in prolonging the service life of the foldable wireless charger, and improves the user experience.

### BRIEF DESCRIPTION OF DRAWINGS

FIG. 1 is a structural schematic diagram of a foldable wireless charger in a folded state according to Embodiment 1 of the present disclosure;

FIG. 2 is a structural schematic diagram of a foldable wireless charger in an unfolded state according to Embodiment 1 of the present disclosure;

FIG. 3 is an exploded view of a support rod of a foldable wireless charger according to Embodiment 1 of the present disclosure;

FIG. 4 is a structural schematic diagram of a partial structure of a foldable wireless charger according to Embodiment 1 of the present disclosure; and

FIG. 5 is an exploded view of a rotational damping mechanism of a foldable wireless charger according to Embodiment 1 of the present disclosure.

### DESCRIPTION OF REFERENCE NUMERALS

1. base; 11. first accommodating groove; 12. second accommodating groove;
2. support rod; 21. rod body; 22. cover plate; 23. cable runway;
3. charger body; 31. easy-to-open structure;
4. rotational damping mechanism; 41. shaft member; 411. shaft shoulder; 421. limiting sleeve; 422. first buffer member; 423. abutting member; 4231. concave-convex snap-fit structure; 4232. limiting block; 43. resisting member; 431. concave-convex snap-fit structure; 44. elastic member; 45. locking member; 46. wear-resistant member; 47. second buffer member;
5. second wireless charging assembly; and
6. third wireless charging assembly.

### DETAILED DESCRIPTION

Implementation, functional features and advantages of the objective of the present disclosure will be further described with reference to the accompanying drawings in connection with the embodiments.

### Embodiment 1

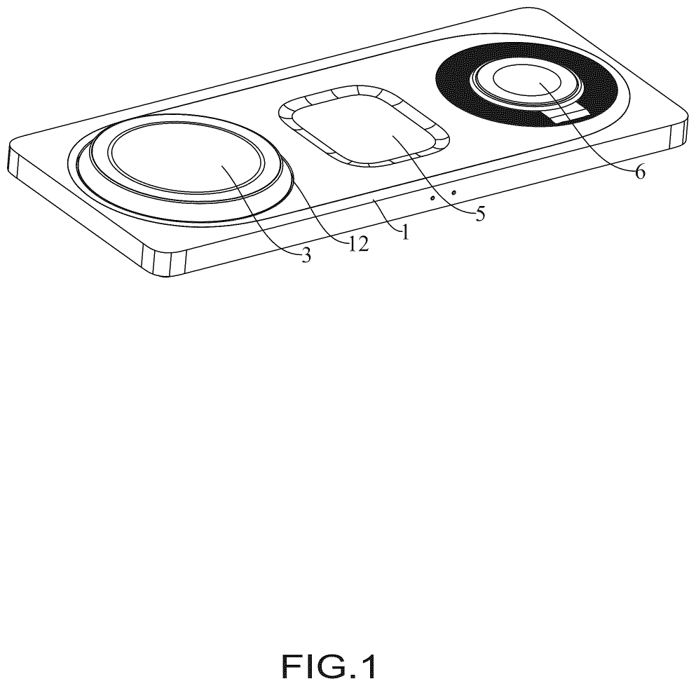

With reference to FIGS. 1-3, a foldable wireless charger, including a cable (not shown in the drawings), a base, a support rod and a charger body 3 connected in sequence, the support rod 2 is rotationally connected to the base 1 and the charger body 3, respectively, a cable outlet is arranged on the base 1, a cable runway 23 is arranged inside the support rod 2, a cable inlet is arranged on the charger body 3, one end of the cable is located in the base 1, the other end of the cable is extended into the charger body 3 through the cable outlet, the cable runway 23 and the cable inlet in sequence, a wireless charging transmission module is arranged inside the charger body 3, and the other end of the cable is connected to the wireless charging transmission module. In detail, a control board assembly is arranged inside the base, and the control board assembly is connected to the wireless charging transmission module through the cable.

The cable outlet is arranged close to the connection point of the base 1 and the support rod 2; and the cable inlet is arranged close to the connection point of the charger body 3 and the support rod 2, such that the cable can be better concealed.

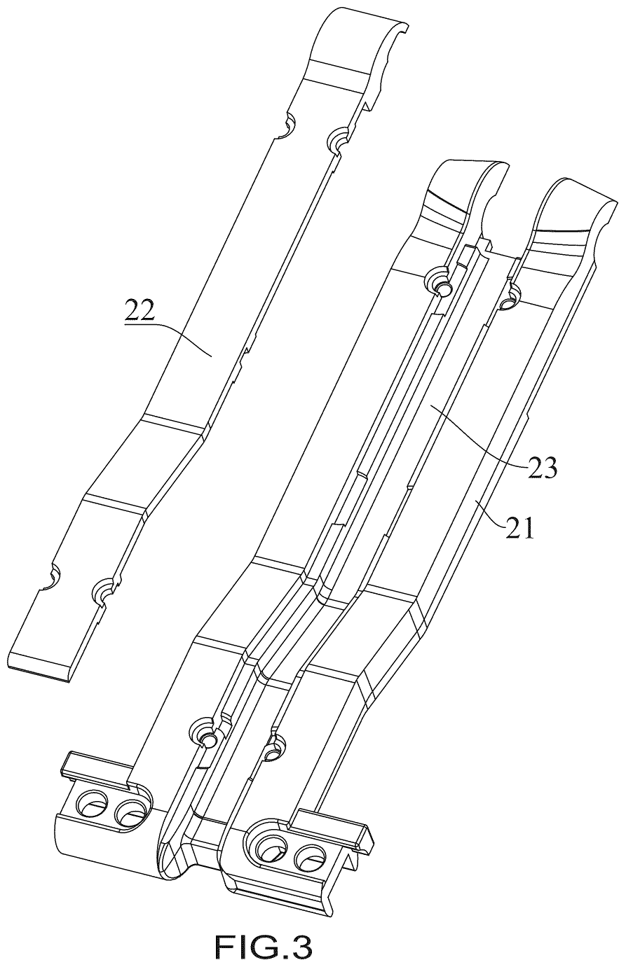

As shown in FIG. 3, specifically, the support rod 2 includes a rod body 21 and a cover plate 22 connected with each other, and the rod body 21 is connected to the cover plate 22 to form a cable runway 23. More specifically, an opening slot is formed on one side of the rod body 21, the opening slot is communicated with both ends of the rod body 21, and the cover plate 22 is located on one side of the rod body 21 and closes the opening of the opening slot.

In order to enable the charger body 3 to better fix a terminal device, optionally, the charger body 3 is provided with a magnetic attraction assembly, which can form a magnetic connection with the charger body 3 when the terminal device contacts the charger body 3. The magnetic attraction assembly includes magnetic steel.

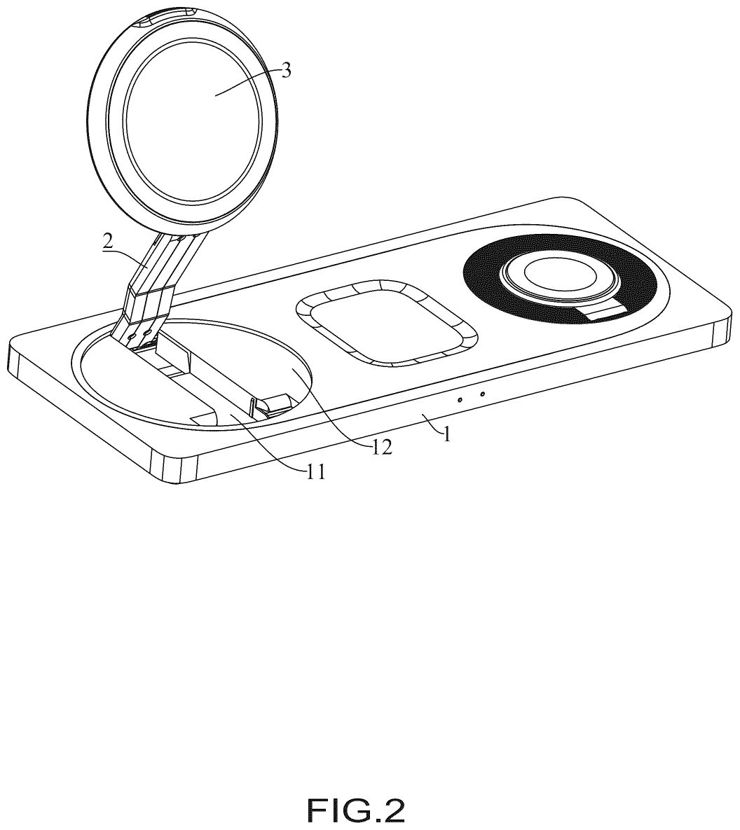

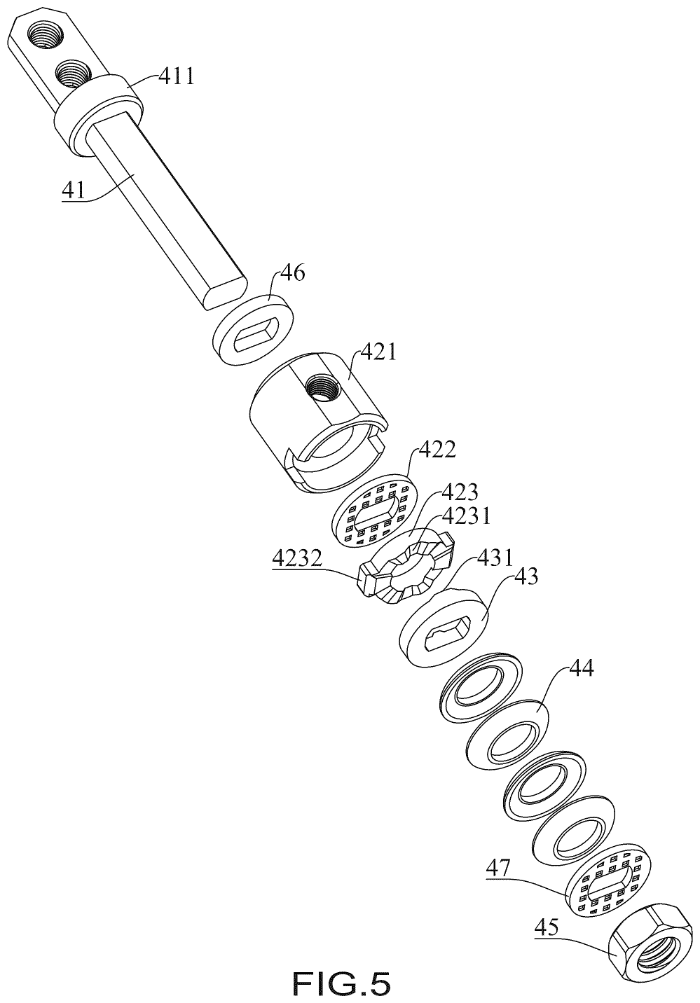

With reference to FIGS. 2, 4 and 5, in order to prevent unexpected rotation of the support rod 2, the support rod 2 is connected to the base 1 through a rotational damping mechanism 4, in the present embodiment, two sides of the support rod 2 are respectively connected to the rotational damping mechanism 4.

The rotational damping mechanism 4 includes a shaft member 41, a fixed sleeve assembly, a resisting member 43, an elastic member 44 and a locking member 45, one end of the shaft member 41 is connected and fixed to the support rod 2, the fixed sleeve assembly can be rotationally sleeved on the shaft member 41, the fixed sleeve assembly is connected and fixed to the base 1, a plurality of concave-convex snap-in structures 4231 are arranged at one end of the fixed sleeve assembly, the resisting member 43 can be slidably sleeved on the shaft member 41, concave-convex snap-fit structures 431 that match the concave-convex snap-in structures 4231 are arranged on one side of the resisting member 43 close to the fixed sleeve assembly, the locking member 45 is fixed at the other end of the shaft member 41, and the elastic member 44 respectively contacts the resisting member 43 and the locking member 45. When the concave-convex snap-fit structures 431 match the different concave-convex snap-in structures 4231, rotation angles of the support rod 2 relative to the base 1 are different. In the present embodiment, there are two concave-convex snap-in structures 4231, that is, when the support rod 2 and the base 1 are in a locked state, there are two rotation angles between the support rod 2 and the base 1, one rotation angle corresponds to the foldable wireless charger being in a folded state, and the other rotation angle corresponds to the foldable wireless charger being in a unfolded state. In other embodiments, the number of the concave-convex snap-in structure 4231 is two and can be three, four or more, in which case, the support rod 2 and the base 1 have a wider range of rotation angles capable of achieving locking, which is more convenient for users to operate.

The elastic member 44 can be a compression spring, a rubber block, a spring plate or other elastic structural members. In the present embodiment, the elastic member 44 is a belleville spring sleeved on the shaft member 41.

The rotational damping mechanism 4 further includes a wear-resistant member 46, the shaft member 41 has a shaft shoulder 411, and the wear-resistant member 46 contacts the other end of the fixed sleeve assembly and the shaft shoulder 411, respectively. The arrangement of the wear-resistant member 46 can slow down the wear rate of the shaft member 41/the fixed sleeve assembly, which is conducive to prolonging the service life of the rotational damping mechanism 4.

Optionally, the fixed sleeve assembly includes a limiting sleeve 421, a first buffer member 422 and an abutting member 423, the limiting sleeve 421 can be rotationally sleeved on the shaft member 41 and connected and fixed to the base 1, a containing cavity is formed at the end of the limiting sleeve 421 close to the resisting member 43, the first buffer member 422 is located between the limiting sleeve 421 and the abutting member 423, the first buffer member is located inside the containing cavity, a limiting groove is formed on the wall of the containing cavity, at least a portion of the abutting member 423 is contained inside the containing cavity, limiting blocks 4232 that match the limiting groove are arranged on the abutting member 423, and the concave-convex snap-in structures 4231 are arranged on one side of the abutting member 423 close to the resisting member 43. In the present embodiment, screw holes are formed on the limiting sleeve 421, and the base 1 is connected and fixed to the limiting sleeve 421 by connecting a screw fitted with the screw holes.

Optionally, the rotational damping mechanism 4 further includes a second buffer member 47, the second buffer member 47 is located between the elastic member 44 and the locking member 45, and the elastic member 44 indirectly contacts the locking member 45 through the second buffer member 47.

In the present embodiment, a threaded section is formed at the other end of the shaft member 41, and the locking member 45 is a nut, which facilitates not only the assembly and production of the rotational damping mechanism 4, but also the circulation of the rotational damping mechanism 4, moreover, pre-tightening force between the fixed sleeve assembly and the resisting member 43 can be accordingly adjusted, thereby further reducing the risk of unexpected rotation of the support rod 2.

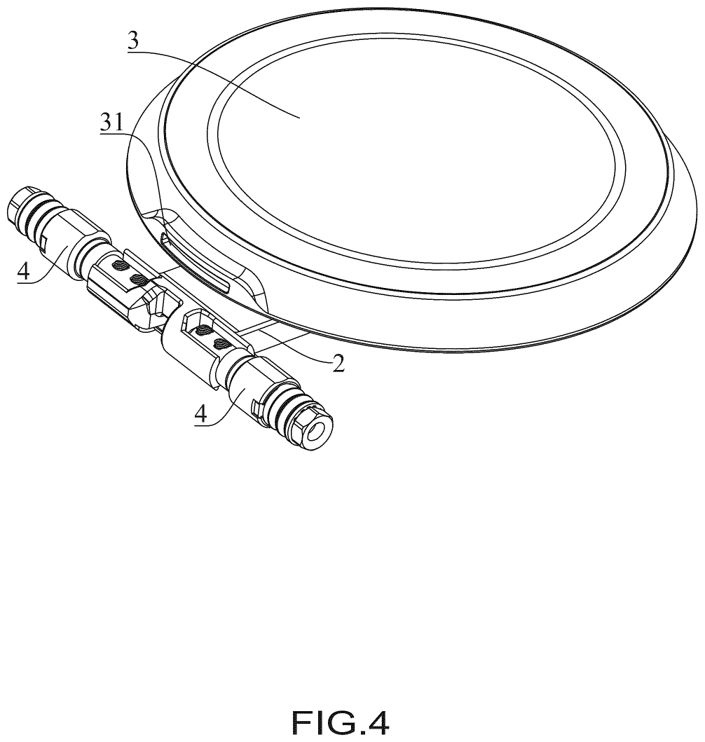

With reference to FIGS. 2 and 4, a first accommodating groove 11 for accommodating the support rod 2 is formed on the base 1, an easy-to-open structure 31 is arranged on the peripheral wall of the charger body 3, and the easy-to-open structure 31 is configured to facilitate the rotation of the charger body 3 by the user to drive the foldable wireless charger to unfold. When the foldable wireless charger is in the folded state, the easy-to-open structure 31 is exposed on the base 1. In the present embodiment, the easy-to-open structure 31 is a buckle groove, such that user can buckle into the buckle groove by a fingernail to drive the charger body 3 to rotate. In other embodiments, the easy-to-open structure 31 can also be a buckle block, and the like.

As shown in FIG. 2, optionally, a second accommodating groove 12 for accommodating a section of the charger body 3 is formed on the base 1, the bottom surface of the second accommodating groove 12 is connected with the first accommodating groove 11, and the arrangement of the second accommodating groove 12 can reduce the probability of the charger body 3 being accidentally opened, which conducive to improving the user experience.

With reference to FIGS. 2 and 4, preferably, the easy-to-open structure 31 is arranged away from the connection point of the charger body 3 and the support rod 2.

As shown in FIG. 1, optionally, a second wireless charging assembly 5 is further arranged on the base 1, and the second wireless charging assembly 5 is configured to charge a wireless Bluetooth earphone box. A third wireless charging assembly 6 is further arranged on the base 1, and the third wireless charging assembly 6 is configured to charge a wireless smart watch.

What is described above is only optional embodiments of the present disclosure and does not limit the patent scope of the present disclosure, and equivalent structure change made by utilizing contents of the description and the drawings in the present disclosure and used directly or indirectly in other related technical fields shall all fall within the scope of protection of the present disclosure in a similar way.

What is claimed is:

1. A foldable wireless charger, comprising a cable, a base, a support rod and a charger body connected in sequence, wherein the support rod is rotationally connected to the base and the charger body, respectively, a cable outlet is arranged on the base, a cable runway is arranged inside the support rod, a cable inlet is arranged on the charger body, one end of the cable is located in the base, and the other end of the cable is extended into the charger body through the cable outlet, the cable runway and the cable inlet in sequence.

2. The foldable wireless charger according to claim 1, wherein the support rod comprises a rod body and a cover plate connected with each other, and the rod body is connected to the cover plate to form a cable runway.

3. The foldable wireless charger according to claim 1, wherein a wireless charging transmission module is arranged inside the charger body, and the other end of the cable is connected to the wireless charging transmission module.

4. The foldable wireless charger according to claim 1, wherein the charger body is provided with a magnetic attraction assembly.

5. The foldable wireless charger according to claim 1, wherein the support rod is connected to the base through a rotational damping mechanism, the rotational damping mechanism comprises a shaft member, a fixed sleeve assembly, a resisting member, an elastic member and a locking member, one end of the shaft member is connected and fixed to the support rod, the fixed sleeve assembly can be rotationally sleeved on the shaft member, the fixed sleeve assembly is connected and fixed to the base, a plurality of concave-convex snap-in structures are arranged at one end of the fixed sleeve assembly, the resisting member can be slidably sleeved on the shaft member, concave-convex snap-fit structures that match the concave-convex snap-in structures are arranged on one side of the resisting member close to the fixed sleeve assembly, the locking member is fixed at the other end of the shaft member, and the elastic member respectively contacts the resisting member and the locking member.

6. The foldable wireless charger according to claim 5, wherein the rotational damping mechanism further comprises a wear-resistant member, the shaft member has a shaft shoulder, and the wear-resistant member contacts the other end of the fixed sleeve assembly and the shaft shoulder, respectively.

7. The foldable wireless charger according to claim 5, wherein the fixed sleeve assembly comprises a limiting sleeve, a first buffer member and an abutting member, the limiting sleeve can be rotationally sleeved on the shaft member and connected and fixed to the base, a containing cavity is formed at the end of the limiting sleeve close to the resisting member, the first buffer member is located between the limiting sleeve and the abutting member, the buffer member is located inside the containing cavity, a limiting groove is formed on the wall of the containing cavity, at least a portion of the abutting member is contained inside the containing cavity, limiting blocks that match the limiting groove are arranged on the abutting member, and the concave-convex snap-in structures are arranged on one side of the abutting member close to the resisting member.

8. The foldable wireless charger according to claim 5, wherein the rotational damping mechanism further comprises a second buffer member, the second buffer member is located between the elastic member and the locking member, and the elastic member indirectly contacts the locking member through the second buffer member.

9. The foldable wireless charger according to claim 1, wherein a first accommodating groove for accommodating the support rod is formed on the base, an easy-to-open structure is arranged on the peripheral wall of the charger body, and the easy-to-open structure is exposed on the base when the foldable wireless charger is in the folded state.

10. The foldable wireless charger according to claim 9, wherein the easy-to-open structure is arranged away from the connection point of the charger body and the support rod.
